(19) United States
(12) Patent Application Publication
(10) Pub. No.: US 2015/0109767 A1
(43) Pub. Date: Apr. 23, 2015

(54) WATER PROOF LIGTH RING

(71) Applicant: Shih-Ping Chen, (US)

(72) Inventor: Yi-Feng Fang, New Taipei City (TW)

(73) Assignee: Shih-Ping Chen, Taipei City (TW)

(21) Appl. No.: 14/056,959

(22) Filed: Oct. 18, 2013

(51) Int. Cl. F21L 4/02; F21V 31/00

(52) U.S. Cl. CPC F21L 4/02; F21V 31/005
USPC 362/158

(57) ABSTRACT

A light ring includes an LED seat having a protection cover and a circuit board which has multiple batteries and LEDs. The circuit board is protected in the protection cover. A transparent tube has an inner diameter which is larger than that of the protection cover. Conductive gel is filled in the transparent tube. The LED seat is inserted into the transparent tube and two ends of the transparent tube are seamlessly sealed so that the LED seat, the protection cover and the circuit board are received in the transparent tube. The LED seat is sealed in the transparent tube so that the light ring is water proof. The LED seat is protected by the transparent tube and the protection cover. The two ends of the transparent tube can be easily opened.

### BACKGROUND OF THE INVENTION

(1) Field of the Invention

The present invention relates to a light ring, and more particularly, to a water proof light ring in which a Light Emitting Diode seat is received.

(2) Description of the Prior Art

People are attracted by fashion, fancy and characterized decoration items so that many decoration items are cooperated with Light Emitting Diodes (LEDs hereinafter) which can be made in different shapes and patterns, and the LEDs provide attractive lights which are welcomed in performance sites, birthday parties, wedding sites and concerts. The LEDs can be made in sticks, rings or the like so that people can hold and swing them to heat up the mood.

The conventional light sticks and rings are disclosed in FIGS. 1 to 3, and the light ring 10 generally comprises an LED seat 11 and a transparent tube 12 in which the conductive glue is filled. The transparent tube 12 is made by soft and flexible silicone so that the two ends of the transparent tube 12 can be bent and mounted to two ends of the LED seat 11. The LEDs 111 of the LED seat 11 are inserted into the transparent tube 12. The LED seat 11 comprises a top cover 112, a bottom cover 113 and a circuit board 114, wherein the circuit board 114 has multiple batteries 115 connected thereon and the LEDs each have welding legs 1111 which are welded to two sides of the circuit board 114. The circuit board 114 has a switch 1141 and the top cover 112 has a pressing portion 1121 which is located corresponding to the switch 1141. The top and bottom covers 112, 113 (plastic covers) are connected to top and bottom of the circuit board 114 respectively, such that the circuit board 114 is hidden between the top and bottom covers 112, 113. The transparent tube 12 can be worn on the user's head, hand or waist. The light emitted by the LEDs 111 in the LED seat 11 passes through the transparent tube 12 via the conductive glue in the transparent tube 12. The light is evenly spread and emitted in multiple directions. When the two ends of transparent tube 12 are bent and the LEDs 111 of the LED seat 11 are inserted into the two bent ends of the transparent tube 12, the top and bottom covers 112, 113 are then connected to the two bent ends of transparent tube 12 and the LED seat 11. The top and bottom covers 112, 113 are located outside of the transparent tube 12.

The pressing portion 1121 of the top cover 112 is defined by a U-shaped gap 1122 as shown in FIGS. 1, 3 so that the pressing portion 1121 is flexible, however, water can easily enters the U-shaped gap 1122. Besides, there is a stepped height difference 1120 and a gap 1121 (FIG. 3) formed between the bottom cover 113 and the transparent tube 12, so that water can easily enters the gap 1121. Furthermore, the stepped height difference 1120 may scrap the user's skin and makes the user feel uncomfortable. When the user swing the body and hand, or when the user separates the two bent ends of the transparent tube 12, the welding legs 1111 of the LEDs 111 are easily separated from the circuit board 114.

There are some shortcomings of the conventional light ring, which are the circuit board 114 may be damaged due to water via the U-shaped gap 1122, the stepped height difference 1120 and a gap 1121 may also introduce water therein to damage the circuit board 114, the stepped height difference 1120 may scrap the user's skin, and when the user taps or swing the light ring, or separates the two bent ends of the transparent tube 12, the welding legs 1111 of the LEDs 111 are easily separated from the circuit board 114.

FIG. 4 discloses another light ring which has a conductive gel stick filled in the non-transparent tube to form a solid light stick 20. The light ring comprises an LED seat 21, a rubber tube 22 and a light stick 20 which is a solid and conductive stick, and is not extended or retracted. The two ends of the light stick 20 are bent and the two ends of the LED seat 21 are inserted into the two bent ends. A rubber tube 22 are mounted to the two bent end of the light stick 20 so as to position the LED seat 21 between the two bent ends of the light stick 20, and protect the two bent ends of the light stick 20 from being separated from each other. The LED seat 21 comprises a circuit board 211, a battery 212 and a LED 213. The light ring can be worn on the user's head, hand or waist. The LED 213 in the LED seat 21 emits light beam in only one direction and the light beam is guided by the light stick 20 in one direction.

However, the light stick 20 is a solid stick which is not extended or retracted so that it can only be used at fixed positions such as being fixed on the clothes. There is only one rubber tube 22 mounted to the two bent end of the light stick 20 to position the LED seat 21 between the two bent ends of the light stick 20, and protect the two bent ends of the light stick 20 from being separated from each other is not good enough. The two ends of the light ring can be easily loosened. The LED seat is not protected by a hard case and is easily crushed. The battery 212 is not removed from the circuit board 211 and the LED 213 can only provide one direction light beam so that the illumination becomes weaker from one end to the other.

The light ring in FIG. 4 has the following shortcomings which are the light stick 20 is a solid stick which is not extended or retracted so that it can only be used at limited positions; the two bent ends of the light ring are easily loosened; the LED seat 22 is not protected by a hard case and is easily crushed; the battery 212 is not removed from the circuit board 211, and the LED 213 can only provide one direction light beam so that the illumination is not even.

The present invention intends to provide a light ring which improves the shortcomings mentioned above.

### SUMMARY OF THE INVENTION

The present invention relates to a light ring and comprises an LED seat having a protection cover and a circuit board which has multiple batteries and LEDs. The circuit board is protected in the protection cover. A transparent tube has an inner diameter which is larger than that of the protection cover. Conductive gel is filled in the transparent tube. The LED seat is inserted into the transparent tube and two ends of the transparent tube are seamlessly sealed so that the LED seat, the protection cover and the circuit board are received in the transparent tube. The LED seat is sealed in the transparent tube so that the light ring is water proof. The LED seat is protected by the transparent tube and the protection cover. The two ends of the transparent tube can be easily opened.

The primary object of the present invention is to provide a light ring which provides a transparent tube and the LED seat is received in the transparent tube so that water cannot access the LED seat and the circuit board is protected.

Another object of the present invention is to provide a light ring which does not have stepped height difference so that it is smooth and does not scrap the user's skin.

Yet another object of the present invention is to provide a light ring wherein the LEDs are received in the transparent tube so that the welding legs of the LEDs are not separated from the two sides of the circuit board.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional light ring;

FIG. 2 is a perspective view to show the conventional light ring;

FIG. 3 is a cross sectional view of the conventional light ring;

FIG. 4 is a cross sectional view of another conventional light ring;

FIG. 5 is an exploded view to show the light ring of the present invention;

FIG. 6 is a perspective view to show the light ring of the present invention;

FIG. 7 is a cross sectional view of the light ring of the present invention;

FIG. 8 is an end cross sectional view of the light ring of the present invention, and

FIG. 9 is a cross sectional view to show that the two ends of the transparent tube of the light ring of the present invention are separated.

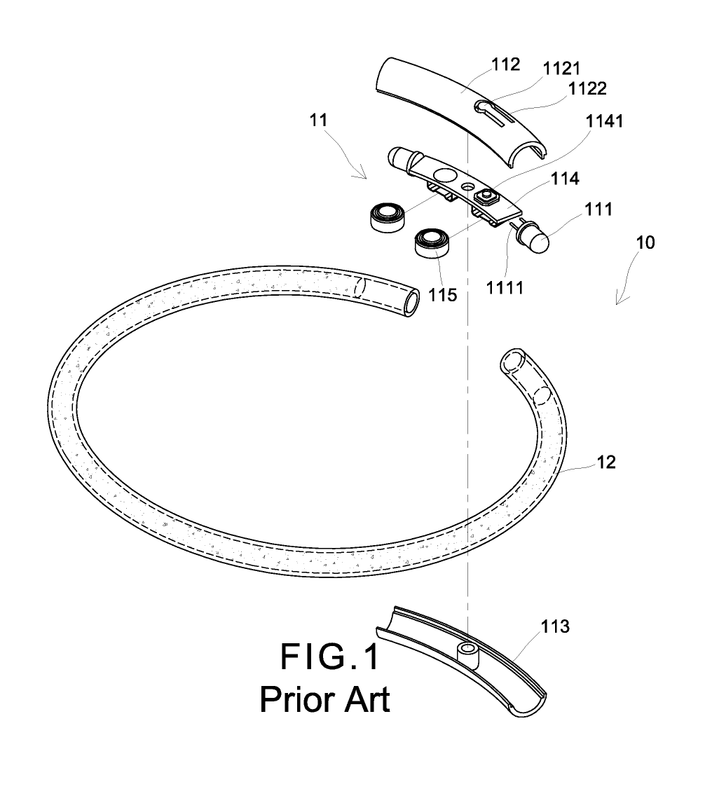

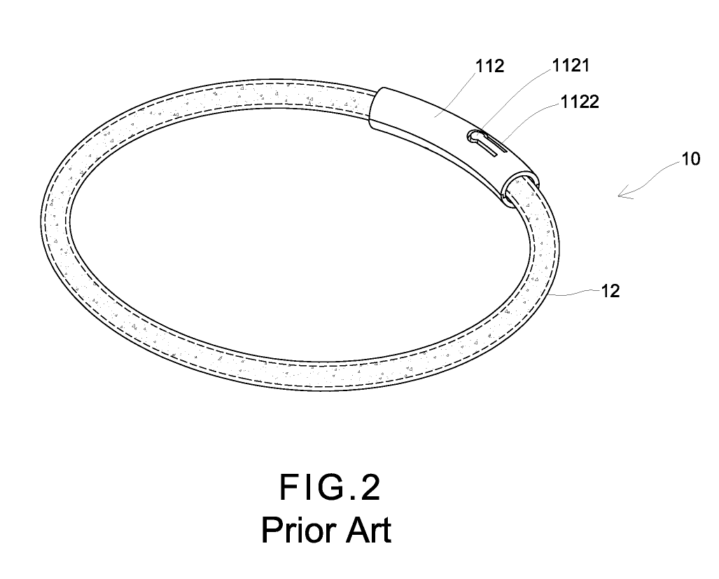

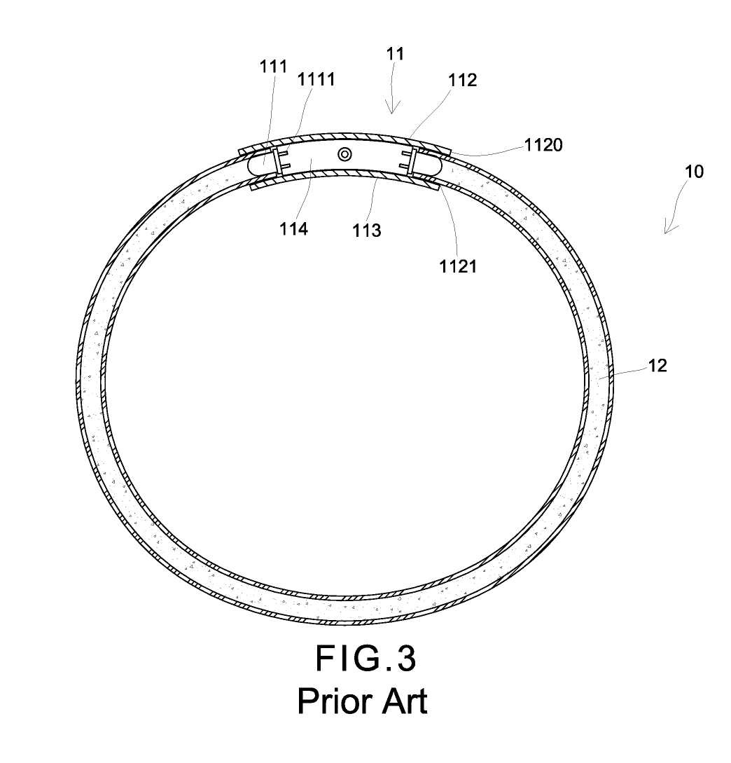

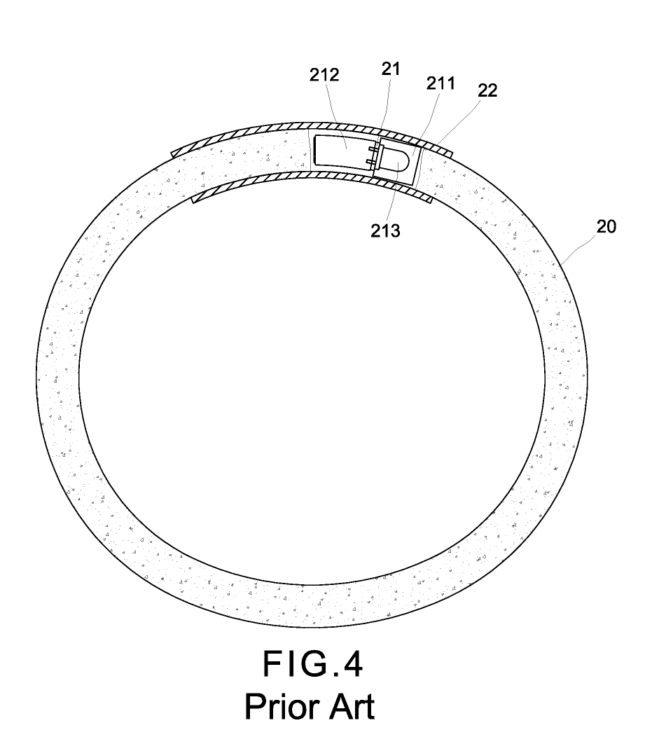

### DETAILED DESCRIPTION OF THE PREFERRED EMBODIMENT

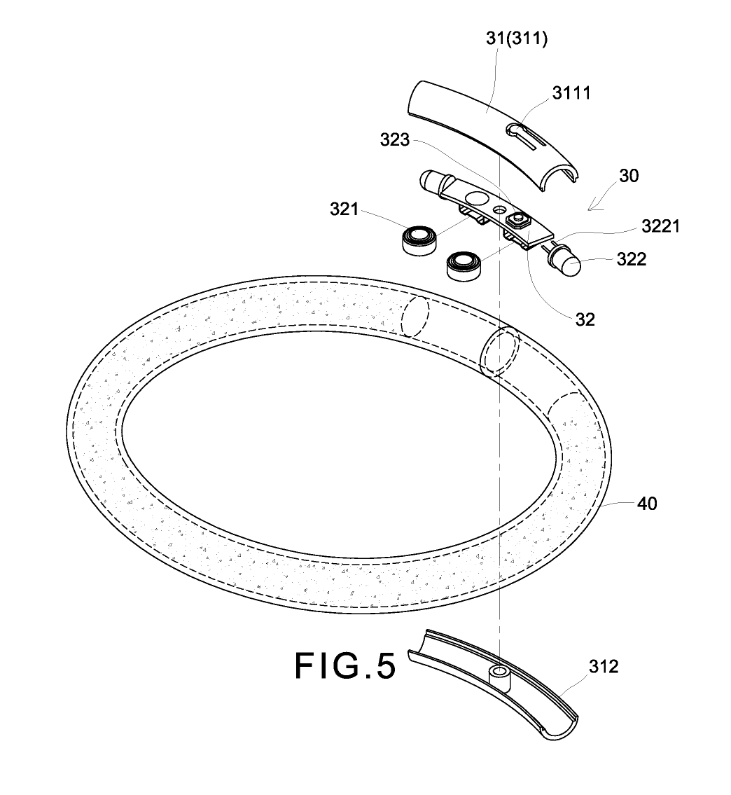

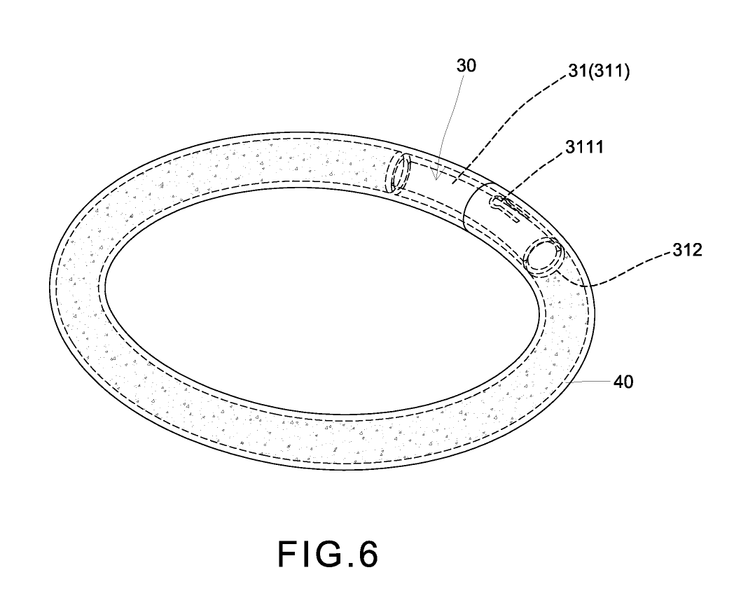

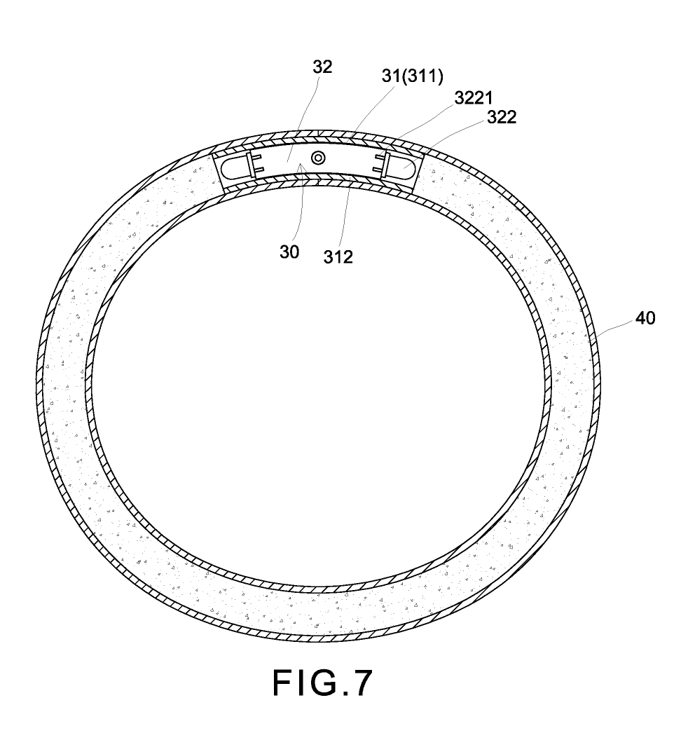

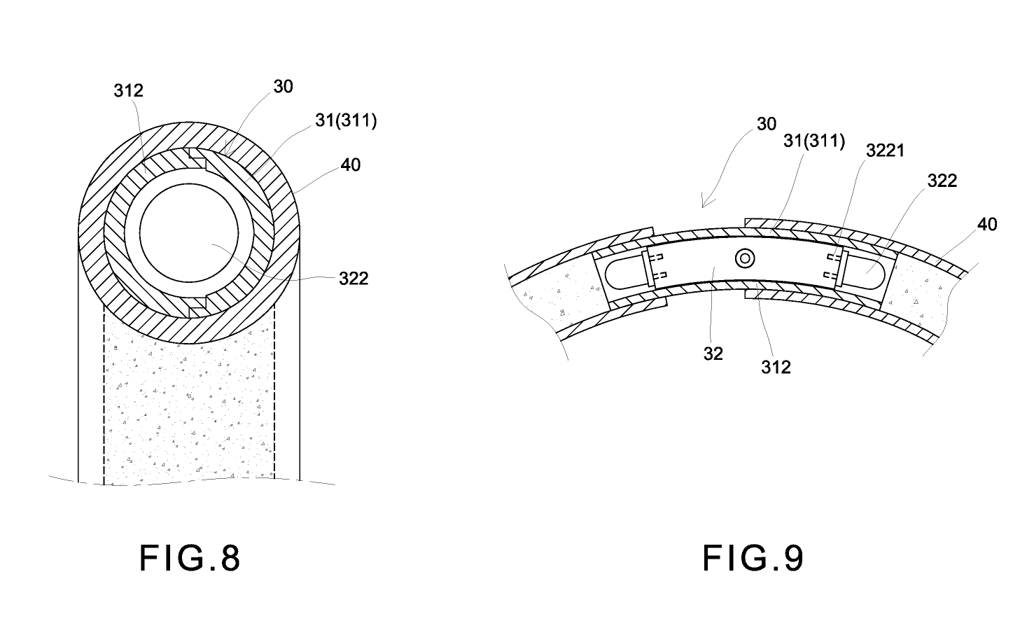

Referring to FIGS. 5 to 8, the light ring of the present invention comprises an LED seat 30 and a transparent tube 40. The LED seat 30 has a protection cover 31 and a circuit board 32 which has multiple batteries 321 and LEDs 322. The LEDs 322 have welding legs 3221 which are welded to two sides of the circuit board 32. The circuit board 32 is protected in the protection cover 31 which has a top cover 311 and a bottom cover 312, the top cover 311 and the bottom cover 312 are respectively connected to the top and the bottom of the circuit board 32. The circuit board 32 has a switch 323, the top cover 311 has a pressing portion 3111 which is located corresponding to the switch 323.

The transparent tube 40 has an inner diameter which is larger than that of the protection cover 31. Conductive gel is filled in the transparent tube 40 which is a flexible and retractable tube. The LED seat 30 inserted into the transparent tube 40. The two ends of the transparent tube 40 are seamlessly sealed so that the LED seat 30, the protection cover 31 and the circuit board 32 are received in the transparent tube 12. The LEDs 322 of the LED seat 30 emit light beams which is guided by the conductive gel in the transparent tube 40 so that the light beams evenly pass through the transparent tube 40 in all directions. The transparent tube 40 can be worn on the user's head, hand, or waist, or on a pet's head, neck or body.

The LED seat 30 and the protection cover 31 are protected by the transparent tube 40 which prevents water from entering the LED seat 30 which is protected by the protection cover 31 and the transparent tube 40. The two ends of the transparent tube 40 are easily separated from each other to replace the batteries 321, as shown in FIG. 9. The transparent tube 40 does not contact the LEDs 322 so that the welding legs 3221 are not separated from the two sides of the circuit board 32.

The advantages of the present invention are that the LED seat 30 is received in the transparent tube 40 so that water cannot access the LED seat 30 and the circuit board 32 is protected. The transparent tube 40 does not have any gap and stepped height difference so that the user can wear the light ring comfortably. The LEDs 322 are not positioned by the two ends of the transparent tube 40, the welding legs 3221 are not separated from the two sides of the circuit board 32. The LED seat 30 is protected by the protection cover 31 which is a hard case. The light ring can be easily worn by people or pets.

The present invention has different installation arrangements from the conventional light rings, wherein the protection cover 31 is located in the transparent tube 40 which has a larger inner diameter to receive the LED seat 30 and the protection cover 31. Therefore, the shortcomings of the conventional light rings are improved by the present invention.

While we have shown and described the embodiment in accordance with the present invention, it should be clear to those skilled in the art that further embodiments may be made without departing from the scope of the present invention.

What is claimed is:

1. A light ring comprising:
an LED seat having a protection cover and a circuit board which has multiple batteries and LEDs, the circuit board being protected in the protection cover, and
a transparent tube having an inner diameter which is larger than that of the protection cover, conductive gel being filled in the transparent tube which is flexible, the LED seat inserted into the transparent tube, two ends of the transparent tube being seamlessly sealed so that the LED seat, the protection cover and the circuit board are received in the transparent tube.

2. The light ring as claimed in claim 1, wherein the LEDs have welding legs which are welded to two sides of the circuit board.

3. The light ring as claimed in claim 1, wherein the protection cover has a top cover and a bottom cover, the top cover and the bottom cover are respectively connected to a top and a bottom of the circuit board.

4. The light ring as claimed in claim 3, wherein the circuit board has a switch, the top cover has a pressing portion which is located corresponding to the switch.
